(19) United States
(12) Patent Application Publication
(10) Pub. No.: US 2025/0324067 A1
(43) Pub. Date: Oct. 16, 2025

(54) SYSTEMS AND METHODS FOR REGION PACKING BASED COMPRESSION

(71) Applicant: OP Solutions LLC, Amherst, MA (US)

(72) Inventors: Hari Kalva, Boca Raton, FL (US); Borivoje Furht, Boca Raton, FL (US); Velibor Adzic, Canton, GA (US); Alena Krause, Coconut Creek, FL (US); Md Eimran Hossain Eimon, Boca Raton, FL (US); Ashan Perera, Boca Raton, FL (US)

(73) Assignee: OP Solutions LLC, Amherst, MA (US)

(21) Appl. No.: 18/902,154

(22) Filed: Sep. 30, 2024

Related U.S. Application Data
(63) Continuation of application No. PCT/US2023/017072, filed on Mar. 31, 2023.
(60) Provisional application No. 63/326,313, filed on Apr. 1, 2022.

(51) Int. Cl. H04N 19/167; H04N 19/172; H04N 19/182; H04N 19/186; H04N 19/20; H04N 19/70

(52) U.S. Cl. CPC H04N 19/167; H04N 19/172; H04N 19/182; H04N 19/186; H04N 19/20; H04N 19/70

(57) ABSTRACT

Systems and methods for video coding and decoding using region packing are provided. At an encoder, a region detection module receives a video frame for encoding, identifies regions of interest in the video frame, and generates a bounding box for each region of interest. A region extractor module obtains the pixels within the bounding box from the video frame. A region packing module receives the identified regions of interest and arranges the bounding boxes within a packed frame substantially reducing the data to be encoded outside the identified regions of interest. A video encoder receives the packed frame and generates an encoded bitstream therefrom. At the decoder, the encoded bitstream is decoded and parameters sufficient to place the regions within a reconstructed frame are extracted. A reconstructed frame is generated which substantially maintains the spatial relationship and size of regions of interest in the original video frame.

### CROSS-REFERENCE TO RELATED APPLICATIONS

This application is a continuation of international application PCT/US2023/017072 filed on Mar. 31, 2023, and titled SYSTEMS AND METHODS FOR REGION PACKING BASED COMPRESSION, which application claims the benefit of priority to U.S. Provisional application Ser. No. 63/326,313, filed on Apr. 1, 2022, and entitled “Systems and Methods for Region Packing Based Compression,” the entirety of each of which is hereby incorporated by reference in its entirety.

### FIELD OF THE DISCLOSURE

The present application relates generally to video encoding and decoding and more particularly relates to video encoding and decoding using object and/or region detection and packing at an encode and region unpacking at the decoder.

### BACKGROUND OF THE DISCLOSURE

A video codec can include an electronic circuit or software that compresses or decompresses digital video. It can convert uncompressed video to a compressed format or vice versa. In the context of video compression, a device that compresses video (and/or performs some function thereof) can typically be called an encoder, and a device that decompresses video (and/or performs some function thereof) can be called a decoder. A format of the compressed data can preferably conform to a standard video compression specification such as HEVC, AV1, VVC and the like.

While video content is often considered for human consumption, there is a growing need for video in industrial settings and other settings in which the content is evaluated by machines rather than humans. Recent trends in robotics, surveillance, monitoring, Internet of Things, etc. have introduced use cases in which a significant portion of all the images and videos that are recorded in the field is consumed by machines only, without ever reaching human eyes. Those machines process images and videos with the goal of completing tasks such as object detection, object tracking, segmentation, event detection etc. Recognizing that this trend is prevalent and will only accelerate in the future, international standardization bodies established efforts to standardize image and video coding that is primarily optimized for machine consumption. For example, standards like JPEG AI and Video Coding for Machines are initiated in addition to already established standards such as Compact Descriptors for Visual Search, and Compact Descriptors for Video Analytics. Further improving encoding and decoding of video for consumption by machines and in hybrid systems in which video is consumed by both a human viewer and a machine is, therefore, of growing importance in the field. As used herein, the term VCM refers broadly to video coding and decoding for machine consumption and while the disclosed systems and methods may be standard compliant, the disclosure is not limited to a specific proposed protocol or standard.

In many applications, such as surveillance systems with multiple cameras, intelligent transportation, smart city applications, and/or intelligent industry applications, traditional video coding may require compression of large number of videos from cameras and transmission through a network for both machine consumption and for human consumption. Subsequently, at a machine site, algorithms for feature extraction may be applied typically using convolutional neural networks or deep learning techniques including object detection, event action recognition, pose estimation and others.

Video and image analysis methods and applications often attempt to detect and track specific classes of objects and regions of interest. In certain applications for machine use, the tasks may only depend on specific objects or regions. Object classes and regions of interest in a video may depend on the tasks an analysis engine or machine task system is expected to perform. In such cases, video content may be compressed by identifying objects of interest in a video frame and only transmitting information related to such objects and omitting other objects or regions which are not of interest. Further compression efficiency may be realized by packing objects of interest identified in a frame into a contiguous region prior to video compression.

### SUMMARY OF THE DISCLOSURE

The presently disclosed method for compressing video and image data focuses on compression that preserves objects in each frame. A general system using this method detects one or more regions of interest or objects of interest in a video frame, tightly packs regions in a frame while discarding regions that are not of interest. As used herein, the term region may refer to an area in an image with a common characteristic (e.g., color, texture, water, grass, sky, etc.) or including a specific object of interest (e.g., cat, dog, person, car, etc.).

The compressed bitstream output by an encoder may include the region location and parameters necessary to place the region in the correct location in the decoded frame at the receiver.

In one embodiment, a video encoder for compression using region packing in accordance with the present disclosure may include a region detection module receiving a video frame for encoding, identifying regions of interest in the video frame based on target task parameters, and generating a bounding box for the region of interest. A region extractor module may be coupled to the region detection module and for each identified region of interest, the region extractor may obtain the pixels within the bounding box from the video frame. A region packing module receives the identified regions of interest and arranges the bounding boxes in a packed frame while substantially omitting data in the frame outside the identified regions of interest. A video encoder receives the packed frame and generates an encoded bitstream therefrom.

In certain embodiments, the bounding box is a rectangle, and the region detector module generates parameters representing the size and location of the bounding box including coordinates in the frame for a corner of the bounding box, a width parameter and a height parameter.

The region detector may include one or more object detectors. The region detector may also detect a region comprising a region of color, texture, or other region characteristic or feature.

A video decoder for decoding a video bitstream encoded using region packing is also provided. This includes a video decoder module receiving an encoded bitstream including at least one encoded region therein. A region unpacking module is coupled to the video decoder module and identifies parameters of a bounding box for the encoded region. A frame reconstruction module is provided and uses the parameters to position and size the bounding box within a reconstructed frame and populate the bounding box with decoded pixels corresponding to the region.

These and other aspects and features of non-limiting embodiments of the present invention will become apparent to those skilled in the art upon review of the following description of specific non-limiting embodiments of the invention in conjunction with the accompanying drawings.

### BRIEF DESCRIPTION OF THE FIGURES

FIG. 1 is a simplified block diagram illustrating components of a region packing based video compression system.

FIG. 2 is a simplified diagram illustrating an exemplary frame of video having multiple objects therein.

FIG. 3 is the simplified diagram of FIG. 3 in which “car” objects and “cat” objects have been identified.

FIGS. 4A-4D are images illustrating an object of interest and various representations of the objects of interest with different treatment of background pixels.

FIGS. 5A and 5B illustrate two examples of region packing in which the objects in FIG. 4 are packed.

FIGS. 6A and 6B illustrate the exemplary packed frame of FIG. 5A output from a decoder and used to recreate the unpacked frame of FIG. 4, including the objects of interest.

FIG. 7 is a simplified flow diagram illustrating the process of unpacking and reconstructing an image frame based on the decoded, packed frame data.

FIG. 8 is a simplified block diagram further detailing an embodiment of a decoder in accordance with the present disclosure.

The drawings are not necessarily to scale and may be illustrated by phantom lines, diagrammatic representations and fragmentary views. In certain instances, details that are not necessary for an understanding of the embodiments or that render other details difficult to perceive may have been omitted.

### DETAILED DESCRIPTION

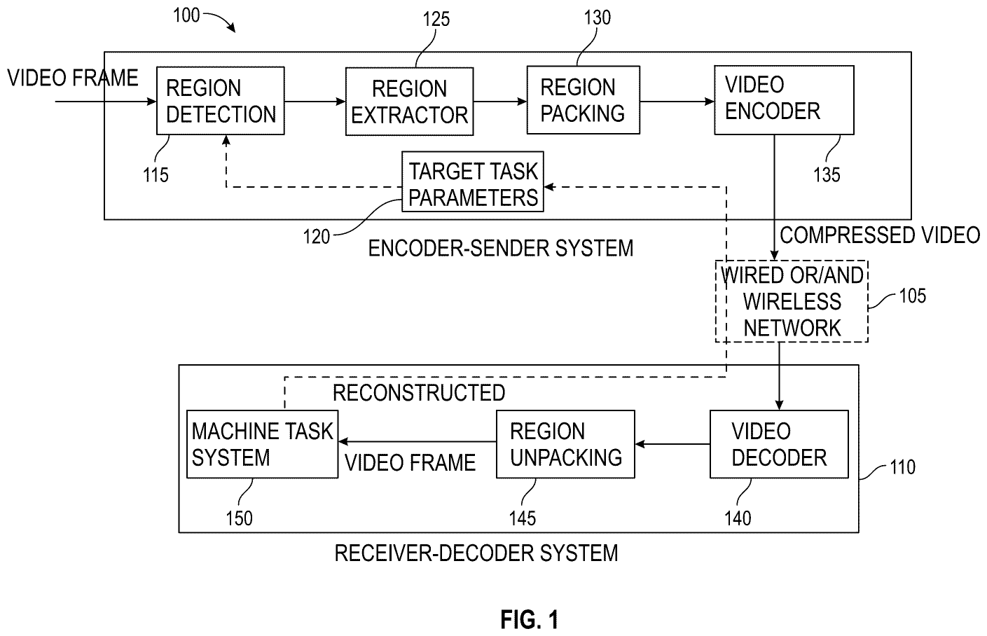

FIG. 1 is a simplified block diagram illustrating components of a region packing based video compression system, including an encoder 100, transmission channel 105 for compressed video, and a receiver/decoder 110.

In the encoder 100, the region detection module 115 takes at least one picture/frame as input and detects regions of interest in the picture. The regions can be different objects in the frame or portions of the picture with similar texture. In some embodiments region detector 115 can use two or more frames as input to identify regions in a frame that have similar motion. The detected regions can be rectangular or any arbitrary shape. It will be appreciated, however, that for efficient compression and packing, regions may preferably be restricted to rectangular shapes. In certain embodiments, each detected region may correspond to an object and in such cases an object detector may be employed to perform the functions of the region detector 115.

A receiver system 110 may send target task parameters 120 to the region detector 115 to change the behavior of the region detection module 115. The target task parameters 120 may indicate the type of regions that the region detection module 115 should identify and detect. The target task parameters 120 may also identify other region parameters, such as whether a rectangular or arbitrary shaped region should be detected. Preferably, receiver system 110 may dynamically request different types of regions or objects that are to be detected.

Region detection module 115 may be comprised of multiple detection systems that can be selected based on the target task parameters 120. For example, region detection module 115 may select a specific detector optimized for a particular class of objects such as a first detector for people objects and a different detector for car objects. Region detection module 115 may be configured to detect regions of specific color such as red regions or specific areas such as water surface or sky. In another example, a region detector may be configured to detect specific objects, such as a backpack. It will be appreciated that some region detection system may be able to detect multiple types of objects.

Region detection module 115 may use previously configured target task parameters 120 without a need for additional information from the receiver system. The region detection module 115 produces bounding boxes of the regions of interest when the regions are rectangular. A bounding box definition specifies the location, size and shape of the bounding box. For example, a bounding box may be defined by the coordinates of the top-left corner of the box, box width, and box height. Any other protocol which allows the position, size and shape to be specified may also be employed. For example, the coordinates of two diagonally opposite corners may define a rectangular bounding box. Bounding boxes of more than one region may overlap. In some cases, the entire area of a frame may be included in detected regions. In some cases, only a small portion of the input frame may be included in the detected regions.

When regions of arbitrary shape are output, then a binary mask may be used to identify the region. For example, a binary mask can be represented with 1s and 0s for each pixel of the image, where a value of 1 indicates that the pixel belongs to the region of interest and a value of 0 indicates the pixel is not in the region of interest.

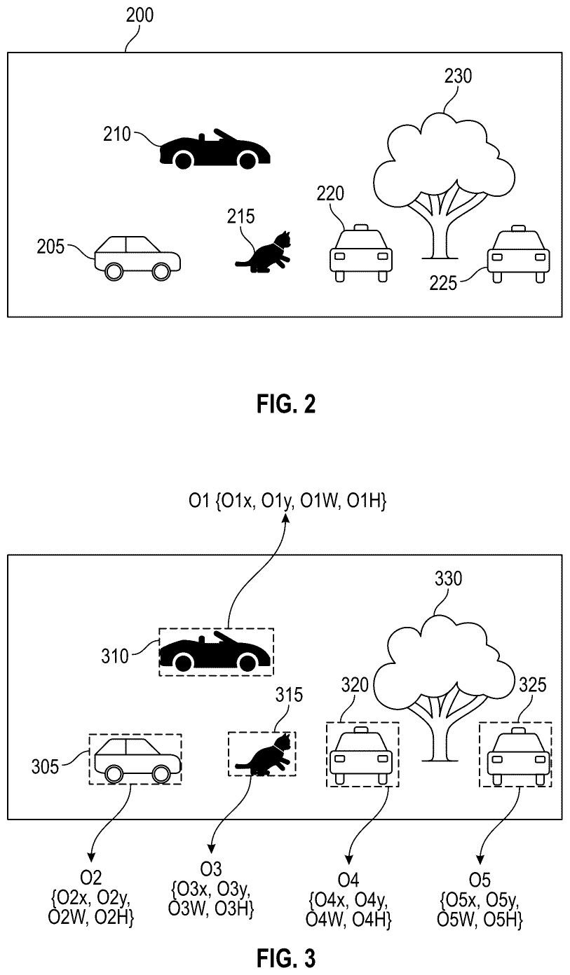

FIG. 2 is an example of a sample frame having a number of objects therein. Region detection module 115 can be configured to identify all objects or only a subset of objects of interest. In this case, there are five objects, a white car 205, a black car 210, a black cat 215, a white car 220, a white car 225, and a tree 230. As illustrated in FIG. 3, a sample frame with multiple objects 305(O2), 310(O1), 315(O3), 320(O4), and 325(O5) detected by detector using a car detector and cat detector. Each object is defined by a bounding box with (x,y) coordinate of the top left corner, the width of the bounding box, and the height of the bounding box. For example, for object 310 O1, (O1x, O1y) are the (x,y) coordinates of the top left corner and O1W is the width of the box, and O1H is the height of the box. In this example, the tree object 330 is not detected and is not processed as a detected region.

The region detector in the example may be configured with target task parameters set to detect at least cats and cars. It will be appreciated that these objects are merely exemplary and a wide range of anticipated objects can be detected.

Following processing by the region detection module 115, the detected regions and/or objects can be applied to a region extraction module 125. Region extraction can be a separate functional element or can be combined with region detection module 115 or region packing module 130. The region extraction module 125 uses the input image and the bounding box as input data and extracts the sub-images that correspond to the detected regions. When regions correspond to specific object class or classes, the extracted sub-images may have the pixels in the bounding box that are not part of the detected object or region of interest. Such pixels are called background pixels. Background pixels can be handled in three different ways 1) replaced by black or another solid color pixel 2) replaced by average pixel value of the all the background pixels, 3) left unmodified.

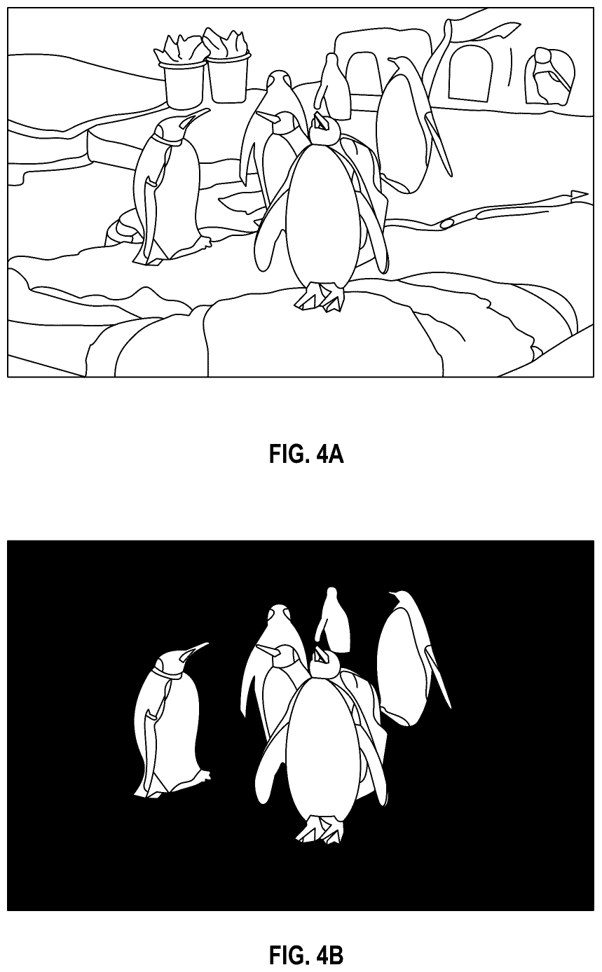

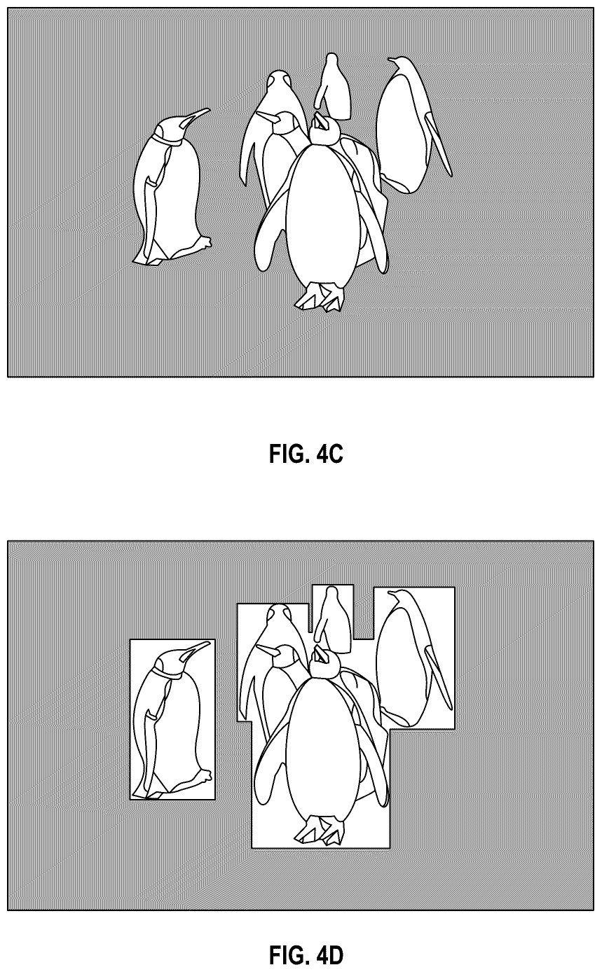

In some systems, background pixel information may help detect the objects of interest on the receiver side and improve the machine task performance at the receiver. This is exemplified in FIGS. 4A through 4D in which penguins are the objects of interest. FIG. 4A illustrates the original image, which includes a number or penguin objects. In FIG. 4B, regions outside the objects are replaced by black pixels. In FIG. 4C, Regions outside the objects are replaced by pixels having an average of background pixels in the object bounding boxes and in FIG. 4D Regions outside the objects in the object bounding boxes left unmodified.

Referring still to FIG. 1, the region packing module 130 extracts the sub-images corresponding to each region and packs them into compact regions for compression. The detected regions are extracted and packed into a compact region and compressed using an efficient video compression. Video compression can generally take place using conventional compression methods, such as those employed in known video codec standards such as VVC, AV1, HEVC and the like.

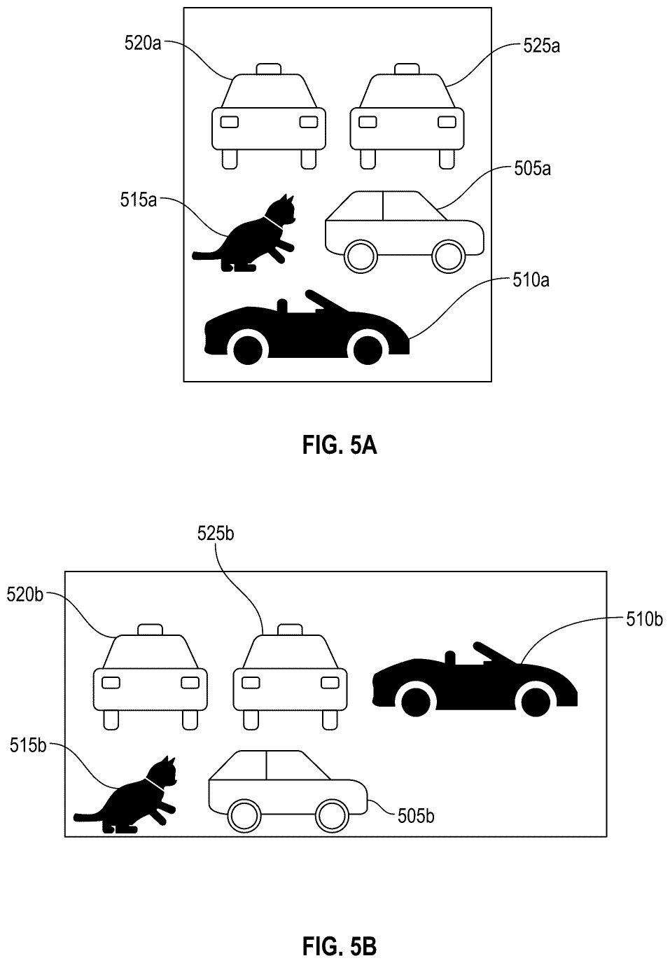

The regions may be packed in multiple arrangements as shown in FIGS. 5A and 5B which illustrate two examples of region packing arrangements in accordance with the present disclosure. The arrangement of objects of interest 505, 510, 515, 520, and 525 may be selected to maximize the compression performance of the video encoder used. The region packing arrangement may be changed as a part of the encoding process. In the example shown in FIG. 5A, having a black cat 515a (object O3) placed above black car 510a (object O1) may produce best compression. In each case, the tree object (FIG. 3, 330) in the original frame is not among the objects of interest and is not detected or included in the packed frame.

Object parameters such as the bounding box and object position are needed at the decoder to recover the position of the objects in the reconstructed frame. The object list, the bounding box, and object placement in the packed frame are preferably included in video bitstream headers. An exemplary syntax for the frame region information header is shown in the table below.

The frame region information may be included in header such as picture or slice header of a frame.

| | Descriptor |
|---|---|
| frame_region_information( ) { | |
| fri_num_regions_minus1 | u(8) |
| for(i=0; i <= fri_num_regions_minus1; i++){ | u(1) |
| fri_object_x_pos | u(16) |
| fri_object_y_pos | |
| fri_object_bbox_x_pos | u(8) |
| fri_object_bbox_y_pos | u(8) |
| fri_object_bbox_width | u(8) |
| fri_object_bbox_height | u(8) |
| } | |
| } | |

### Frame Regions Information Semantics

fri_num_regions_minus1—number of object regions in the packed frame
fri_object_x_pos—x coordinate of object in the packed frame
fri_object_y_pos—y coordinate of object in the packed frame
fri_object_bbox_x_pos—x coordinate of object in the reconstructed frame
fri_object_bbox_y_pos—y coordinate of object in the reconstructed frame
fri_object_bbox_width—width of the object
fri_object_bbox_height—height of the object

Frame regions information semantics can be extended to support more than 2 dimensions. For example, to support 3-dimensional video, the semantics will be extended with three additional parameters:
fri_object_z_pos—z coordinate of object in the packed frame
fri_object_bbox_z_pos—z coordinate of object in the reconstructed frame
fri_object_bbox_depth—depth of the object

The video encoder 135 is suitable for encoding single frames or a sequence of frames. An image encoder may also be used. Frames with packed regions are encoded with compression efficiency suitable for targeted use at the receiver/decoder 140. The frame packing arrangement is usually determined as a part of the encoding step. The encoder 135 receives the original frame and the region bounding boxes as input and as a part of the encoding process, determines the region packing arrangement that maximizes the compression performance. The encoder 135 includes the frame region information in the compressed video bitstream. The original video width and height are also encoded in the compressed video bitstream. In the case of 3-dimensional video, the Point Cloud Compression (PCC) encoder can be used instead or in conjunction with the video encoder.

The corresponding video decoder 140 uses the compressed video bitstream as input and outputs a decoded a region packed frame and the frame region information. The original video width and height are also decoded from the video bitstream. Video decoder 140 can take the form of known video decoders that are compliant with the encoding scheme used by encoder 135, such as VVC, HEVC, AV1 standard compliant encoders and the like.

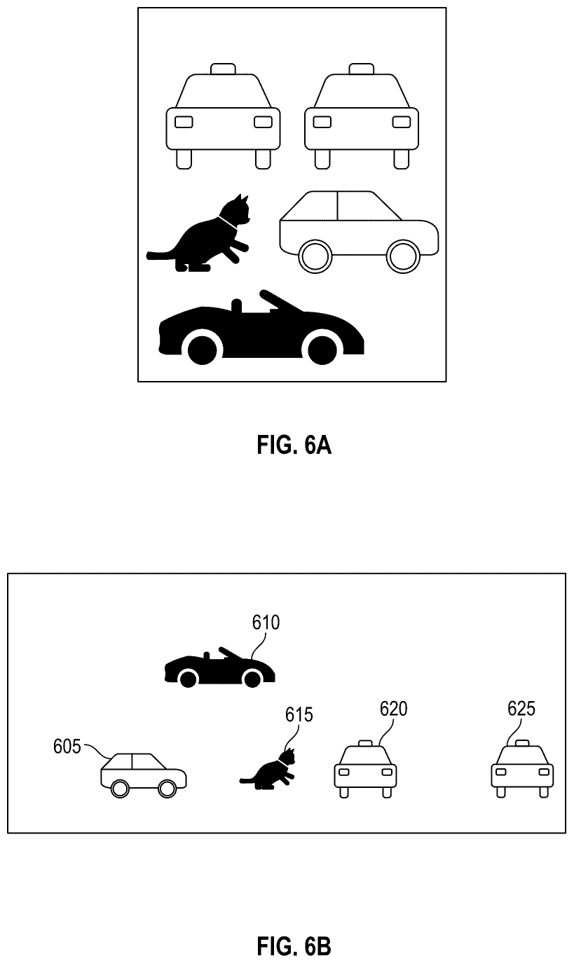

As generally illustrated in FIGS. 6A and 6B, the region unpacking stage 145 receives the decoded frame which includes the packed objects (FIG. 6A), frame region information, and original frame dimensions from the video decoder 140 as input and reconstructs the frame with objects/regions 605, 610, 615, 620, 625 placed in their correct positions from the original frame (FIG. 6B). The reconstruction process in this case will copy pixels in the bounding box of a given object to the corresponding location of the object in the original frame. The reconstructed frame in FIG. 6B is used as input to the machine task system 150 that performs the desired operations.

The regions from the packed frame (FIG. 6A) are extracted and placed in corresponding places in the reconstructed frame (FIG. 6B) using the bounding box information for each of the packed regions. The reconstructed frame preferably has the same dimensions as the input frame, although scaling of the reconstructed frame is also possible. The reconstructed frame will generally not have regions that are not detected and packed at the encoder system 100. In this example, the tree region object 330 shown in FIG. 3 was not detected and was not packed in the bitstream and will not be present in the reconstructed frame. Similarly, background information around the objects in the original frame may not be present in the packed bitstream, further reducing the data to be encoded and decoded.

The machine task system 150 uses the reconstructed frame (FIG. 6B) as input to perform the intended tasks. The machine task system 150 may dynamically send target task parameters to the encoding system 100. In some embodiments, the encoding system 100, in response to the updated target task parameters, can preferably update the type and number of region/object detectors selected to encode the video frame.

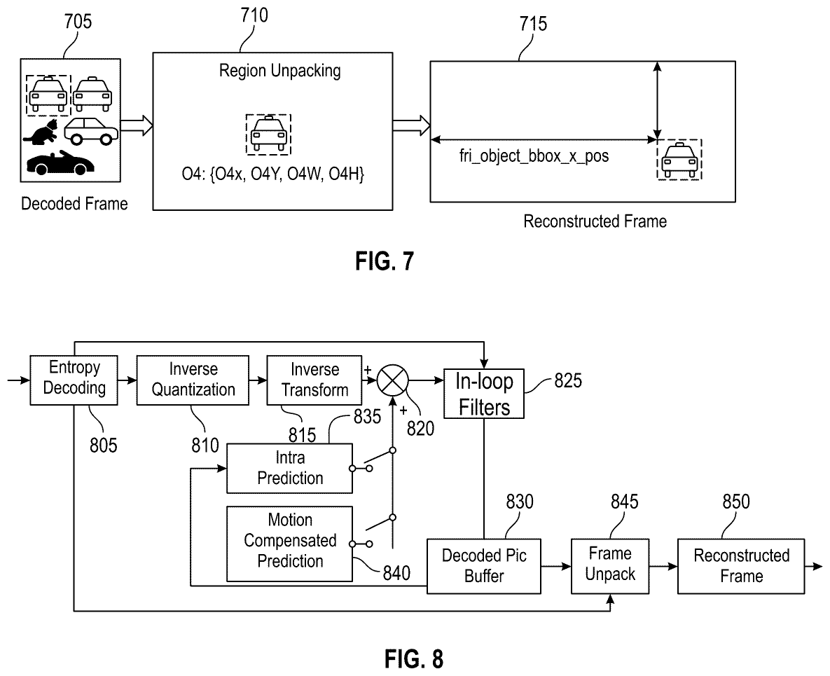

A simplified example of the region unpacking for a single region/object in the decoded frame is presented in FIG. 7. The figure further illustrates the process for unpacking objects, such as object “O4”. As noted in connection with the object packing process, each detected object is packed with information sufficient to identify the object/regions position and size in the original frame. In one example, this can take the form of the coordinates of one corner of a rectangular bounding box, e.g., the top left corner, as well as the width and height of the object. Referring to FIG. 7, the video decoder 140 will output the packed frame 705. In the region unpacking stage 145, information about each object is used to position the object in the reconstructed frame. In region unpacking for object O4 705, the coordinates O4x and O4y locate the top left hand corner of a rectangular bounding box for the object in the reconstructed frame, O4W specifies the width of the bounding box and O4H specifies the height of the bounding box for O4. The remaining objects are extracted and placed in the reconstructed frame 715 concurrently or subsequently using substantially the same process.

FIG. 8 is a simplified block diagram further illustrating an example of a decoder in accordance with the present disclosure. Coded video is received at an entropy decoding module 805. In the entropy decoding module 805 the semantic and video payload information is decoded from the binary representation and passed to an inverse quantization (for video payload) module 810 and in-loop filters 825 (for video information), and to the frame unpacking component 845 (for packing semantics). The inverse quantization module 810 applies the operation that inverts the quantization employed during encoding and produces the frequency coefficients of the residual. An inverse transform processor 815 is coupled to the inverse quantization module 810 and applies complementary operations that inverts the forward transform employed during encoding and produces pixel values of the residual. These values are added in a summation stage 820 to the previously decoded frames to reconstruct current frame. The in-loop filters 825 apply processing at the boundaries of the predicted blocks in order to smooth-out the abrupt changes between blocks.

A decoded picture buffer 830 stores the decoded video frames that are used for prediction of the other frames in the independent group-of-pictures. The size of the buffer is typically controlled by the decoder parameters.

The decoder includes an intra prediction processing block 835 in which the pixel value prediction is performed based on the information contained in the current frame. All the previously decoded blocks of the frame can be used to predict next block in the frame. The decoder further includes a motion compensated prediction module 840 in which the blocks in the current frame are predicted from the collocated or displaced matching blocks in the neighboring frames, using motion vectors to describe displacement.

A frame unpack module 845 is coupled to the decoded picture buffer and the entropy decoder 805. The frame unpack module 845 takes the fully decoded video frames and using the packing semantic information received from the entropy decoder 805 unpacks the regions placing them in the specified locations in the reconstructed frame, such as illustrated in FIG. 7.

The reconstructed frame processor 850 provides the final output of the decoder that generally has the dimensions of the input frame at the encoder side and contains all the regions of interest in locations as in the input frame. It will be appreciated, however, that in some applications encoder/decoder might decide to encode locations and scales of the regions that do not match the input locations and scales.

### Preliminary Experimental Results

| | Blk | Blk | | | | |
|---|---|---|---|---|---|---|
| | Packed | Packed | Original | Original | BPP | mAP |
| QP | bpp | mAP | BPP | mAP | diff | diff |
| QP_22 | 0.543614488 | 78.68% | 0.730596241 | 81.31% | −25.59% | −2.64% |
| QP_27 | 0.321519917 | 79.99% | 0.430880522 | 80.05% | −25.38% | −0.06% |
| QP_32 | 0.186056967 | 79.46% | 0.244208507 | 79.46% | −23.81% | 0.00% |
| QP_37 | 0.104373855 | 76.20% | 0.131732047 | 77.60% | −20.77% | −1/40% |
| QP_42 | 0.056217798 | 71.74% | 0.068033579 | 72.44% | −17.37% | −0.70% |
| QP_47 | 0.029191201 | 57.09% | 0.033660653 | 58.49% | −13.28% | −1.40 |

| BD-rate | BD-mAP |
|---|---|
| −12.05% | 0.688338 |

Preliminary experimental results are shown in the table above. In this example, a sample dataset consisting of 100 images was processed using an embodiment of a region packing based video system in accordance with FIG. 1.

With an object detector from the Detectron2 library (Girshick et al. 2018, Detectron, retrieved from https://github.com/facebookresearch/detectron), inferences for each frame are used to black-out all pixels outside of the object bounds. Region coordinates output by the model are then used to perform packing such that all regions are arranged into an optimal bin size. Each of the packed frames serve as input to the video encoder.

On the decoder side, the compressed frames are unpacked using the region and location parameters included in the bitstream. The reconstructed images are then finally processed through an object segmentation model implemented with Detectron2.

The table describes results using a VVC reference encoder (Bross et al., Overview of the Versatile Video Coding (VVC) Standard and its Applications. IEEE Transactions on Circuits and Systems for Video Technology 31, 10 (October 2021), 3736-3764. DOI: https://doi.org/10.1109/TCSVT.2021.3101953), VTM, in intra-coding mode. The columns indicate the average bits per pixel (BPP) and mean average precision (mAP) across quantization parameters 22, 27, 32, 37, 42, and 47 for the aforementioned 100 images. “Blk Packed” corresponds to packed frames where a black color is used for any pixels outside of a region box. “Original” columns show results for the same 100 images not processed with region packing.

Overall, in this example region packing significantly reduces BPP while simultaneously maintaining high mAP. An encoded frame processed with region packing, in the majority of cases, has comparable precision to that of the original-untransformed video frame. In general, BD-rate numbers show that such a packing system can produce outputs with lower BPP for the same precision. Similarly, BD-mAP results indicate that there is some potential to improve mAP for equivalent BPP.

It is to be noted that any one or more of the aspects and embodiments described herein may be conveniently implemented using digital electronic circuitry, integrated circuitry, specially designed application specific integrated circuits (ASICs), field programmable gate arrays (FPGAs) computer hardware, firmware, software, and/or combinations thereof, as realized and/or implemented in one or more machines (e.g., one or more computing devices that are utilized as a user computing device for an electronic document, one or more server devices, such as a document server, etc.) programmed according to the teachings of the present specification, as will be apparent to those of ordinary skill in the computer art. These various aspects or features may include implementation in one or more computer programs and/or software that are executable and/or interpretable on a programmable system including at least one programmable processor, which can be special or general purpose, coupled to receive data and instructions from, and to transmit data and instructions to, a storage system, at least one input device, and at least one output device.

Appropriate software coding can readily be prepared by skilled programmers based on the teachings of the present disclosure, as will be apparent to those of ordinary skill in the software art. Aspects and implementations discussed above employing software and/or software modules may also include appropriate hardware for assisting in the implementation of the machine executable instructions of the software and/or software module.

Such software may be a computer program product that employs a machine-readable storage medium. A machine-readable storage medium may be any medium that is capable of storing and/or encoding a sequence of instructions for execution by a machine (e.g., a computing device) and that causes the machine to perform any one of the methodologies and/or embodiments described herein. Examples of a machine-readable storage medium include, but are not limited to, a magnetic disk, an optical disc (e.g., CD, CD-R, DVD, DVD-R, etc.), a magneto-optical disk, a read-only memory “ROM” device, a random access memory “RAM” device, a magnetic card, an optical card, a solid-state memory device, an EPROM, an EEPROM, Programmable Logic Devices (PLDs), and/or any combinations thereof. A machine-readable medium, as used herein, is intended to include a single medium as well as a collection of physically separate media, such as, for example, a collection of compact discs or one or more hard disk drives in combination with a computer memory. As used herein, a machine-readable storage medium does not include transitory forms of signal transmission.

Such software may also include information (e.g., data) carried as a data signal on a data carrier, such as a carrier wave. For example, machine-executable information may be included as a data-carrying signal embodied in a data carrier in which the signal encodes a sequence of instruction, or portion thereof, for execution by a machine (e.g., a computing device) and any related information (e.g., data structures and data) that causes the machine to perform any one of the methodologies and/or embodiments described herein.

Examples of a computing device include, but are not limited to, an electronic book reading device, a computer workstation, a terminal computer, a server computer, a handheld device (e.g., a tablet computer, a smartphone, etc.), a web appliance, a network router, a network switch, a network bridge, any machine capable of executing a sequence of instructions that specify an action to be taken by that machine, and any combinations thereof. In one example, a computing device may include and/or be included in a kiosk.

It is to be noted that any one or more of the aspects and embodiments described herein may be conveniently implemented using one or more machines (e.g., one or more decoder and/or encoders that are utilized as a user decoder and/or encoder for an electronic document, one or more server devices, such as a document server, etc.) programmed according to the teachings of the present specification, as will be apparent to those of ordinary skill in the computer art. Appropriate software coding can readily be prepared by skilled programmers based on the teachings of the present disclosure, as will be apparent to those of ordinary skill in the software art. Aspects and implementations discussed above employing software and/or software modules may also include appropriate hardware for assisting in the implementation of the machine executable instructions of the software and/or software module.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve embodiments as disclosed herein. Accordingly, this description is meant to be taken only by way of example, and not to otherwise limit the scope of this invention.

In the descriptions above, phrases such as “at least one of” or “one or more of” may occur followed by a conjunctive list of elements or features. The term “and/or” may also occur in a list of two or more elements or features. Unless otherwise implicitly or explicitly contradicted by the context in which it is used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” In addition, use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and sub-combinations of the disclosed features and/or combinations and sub-combinations of several further features disclosed above. In addition, the logic flows depicted in the accompanying figures and/or described herein do not necessarily require the particular order shown, or sequential order, to achieve desirable results. Other implementations may be within the scope of the disclosure.

What is claimed is:

1. A video encoder for compression using region packing comprising:
a region detection module receiving a video frame for encoding, identifying at least one region of interest in the video frame based on target task parameters, and generating a bounding box for each identified region of interest;
a region extractor module coupled to the region detection module and, for each identified region of interest, the region extractor obtains the pixels within the bounding box from the video frame;
a region packing module receiving the identified regions of interest and arranging the bounding boxes in a packed frame, the packed frame substantially omitting data in the frame outside the identified regions of interest; and
a video encoder receiving the packed frame and generating an encoded bitstream therefrom.

2. The encoder of claim 1 wherein the bounding box is a rectangle and wherein the region detector module generates parameters including coordinates in the frame for a corner of the bounding box, a width parameter and a height parameter.

3. The encoder of claim 1, wherein the parameters of the bounding box are encoded in a header of the encoded bitstream.

4. The encoder of claim 1, wherein the region detector includes at least one object detector.

5. The encoder of claim 1, wherein the region can comprise a region of color.

6. A video decoder for a video bitstream encoded using region packing:
a video decoder receiving an encoded bitstream including at least one encoded region therein;
a region unpacking module identifying parameters of a bounding box for the at least one encoded region; and
a frame reconstruction module using the parameters to position and size the bounding box within a reconstructed frame and populate the bounding box with decoded pixels corresponding to the region.

7. The decoder of claim 6, wherein the bounding box is rectangular, and the parameters include coordinates of a corner of bounding box, a width parameter and a height parameter.

8. The decoder of claim 6, wherein the reconstructed frame has substantially the same dimensions as a frame of the video prior to encoding and the reconstruction module places each encoded region in substantially the same position in the reconstructed frame as it had in the video prior to encoding.

9. The decoder of claim 6, wherein the parameters are extracted from header information in the encoded bitstream.
